(19) United States
(12) Patent Application Publication
(10) Pub. No.: US 2015/0144576 A1
(43) Pub. Date: May 28, 2015

(54) Mechanical filtering process for dehydrating muds and filter press implementing said process

(71) Applicant: S.P. SRL, Cittadella (PD) (IT)

(72) Inventor: Ugo Salvato, Cittadella (PD) (IT)

(21) Appl. No.: 14/404,615

(22) PCT Filed: Jun. 25, 2012
(86) PCT No.: PCT/IB2012/053184

§ 371 Date: Jan. 15, 2015

(30) Foreign Application Priority Data
Jun. 12, 2012 (IT) PD2012A000190

(51) Int. Cl. B01D 25/12; B01D 25/21

(52) U.S. Cl. CPC B01D 25/12; B01D 25/215
USPC 210/780; 210/231

(57) ABSTRACT

A mechanical filtering process for dehydrating muds includes the step of introducing a mass of mud to be dehydrated between mechanical filtering porous plates and the step of applying a compression force on the mass of mud by the porous plates, thus causing a liquid fraction to be removed from the mass of mud, the liquid fraction being filtered through the porous plates while the solid fraction remains between the plates. The compression force is combined with a twisting moment on the mass of mud by the porous plates, which causes the additional removal of a residual liquid fraction from the mass of mud.

### FIELD OF THE INVENTION

The present invention concerns filter presses for dehydrating muds, and in particular concerns a mechanical filtering process for dehydrating muds and a highly effective filter press suited to implement said process.

### BACKGROUND OF THE INVENTION

The muds resulting from production processes of various types must undergo a series of treatments before their disposal.

Among these treatments, some of which are aimed at reducing the pollution load, the mud dehydration treatment is known, which consists in reducing the quantity of water present in the mass of mud.

The dehydrated mud can thus be transported to a disposal site or be disposed of in another way, for example in incinerators, while the liquid fraction is recirculated in the mud treatment system, or sent to a purification system.

Various techniques and pieces of equipment are known that are used for dehydrating muds, among which the mechanical filtering dehydration technique is known, which consists in making the mud pass through a filtering means, usually a filtering fabric, which holds the solid fraction while allowing the liquid fraction to pass therethrough.

For this purpose filter presses are known, which comprise a plurality of facing porous plates, said plates being in turn constituted by filtering or draining fabrics. The mud to be dehydrated is introduced between said plates and pressed, so that the liquid fraction contained in the mud introduced between the plates passes through said draining fabric while the solid fraction is held in the same fabric. The pressure exerted on the mass of mud to be dehydrated is applied by pressing the mud between the plates and furthermore it is applied directly by the plates, for example by means of hydraulic members acting on the plates.

The liquid fraction is conveyed towards one or more collection points or ducts or circuits, while the solid fraction remains between the plates, substantially forming a sort of panel or wafer.

In order to discharge the solid fraction, the plates are moved away from each other and the dehydrated mud wafer is removed from the filter press so that it falls into a collection hopper due to gravity.

In order to maximize the effectiveness of the filtering dehydration process, it is advisable that the space included between the plates under pressure be sufficiently reduced, so that even the liquid fraction contained in the innermost layers of the liquid panel can be eliminated from the mass of mud.

Even in this way, however, the dehydrated mud panel obtained from the mechanical filtering still contains a certain quantity of liquid that can be eliminated by subjecting the mud panel to further drying steps.

### SUMMARY OF THE INVENTION

The subject of the present invention is a new type of mechanical filtering process for dehydrating muds, together with a highly effective filter press suited to implement said process.

It is the main object of the present invention to maximize efficiency in the removal of the liquid fraction from the mass of mud to be dehydrated.

It is another object of the present invention to reduce energy costs thanks to the increased efficiency in the removal of the liquid fraction.

It is an advantage of the present invention to reduce the overall dimensions of the filter press that, being modular, can be arranged according to the space available. Another advantage of the present invention lies in that it can be adapted to the quantity of muds to be treated as, being modular, the filter press can be sized accordingly.

These and other direct and complementary objects are achieved by the new mechanical filtering process for dehydrating muds and by a filter press implementing said process.

The new process comprises the following steps:

introduction of a mass of mud to be dehydrated between porous plates for mechanical filtering;

a first step of application of a compression force on the mass of mud by said porous plates, in the direction orthogonal to the same plates, causing a liquid fraction to be removed from the mass of mud, wherein said liquid fraction is filtered through the porous plate while the solid fraction remains between the plates;

a second step of application of said compression force combined with a twisting moment to said mass of mud by said porous plates, with vibration, if necessary, causing the further outflow of a residual liquid fraction that is filtered through the porous plates while the solid fraction remains between the plates.

When said twisting moment is applied, the mass of mud actually undergoes a shearing stress that causes even micro fissures in the mass of mud, creating preferential channels through which the residual liquid fraction is removed from the mass of mud.

Therefore, with the same time of compression of the mass of mud, a higher degree of dehydration is obtained compared to the degree of hydration obtained by applying the known mechanical filtering processes.

Said higher efficiency thus leads to a reduction in energy consumption and to the possibility to reduce the size of the filter presses that, with the same size and in the same time, process a larger quantity of muds.

Once the application of said stress has been completed, the dehydrated mud panel obtained in this way is discharged and conveyed to further natural or induced drying steps.

The liquid fraction is then collected and conveyed towards further treatment processes or reused in various ways.

The filter press implementing said process comprises a frame, at least one pair of facing porous plates suited to translate with respect to each other thus increasing/decreasing their mutual distance, mechanical members suited to move one or both of the plates of each pair, at least one duct suited to convey the mass of mud to be dehydrated between said plates, at least one line for the collection and outflow of the liquid fraction removed from the mass of mud through filtration, at least one hopper suited to collect the dehydrated mud panels, and wherein said mechanical members act on at least one of said plates in order to exert a compression force on the mass of mud introduced between the same plates, by moving the plates near each other, and a twisting moment, by rotating at least one of said plates on the plane where it lies.

Said compression force is applied for a determined time interval, sufficient to cause the outflow of a liquid fraction contained in the mass of mud.

At the end of said time interval, maintaining in any case said compression force, the new filter press applies at the same time said twisting moment for a further predetermined time interval, causing the further outflow of a residual liquid fraction.

Said rotary movement of one or both of said plates is preferably alternated in both directions and associated with a vibratory motion to maximize the quantity of liquid fraction removed from the mass of mud.

Said pairs of plates can be arranged on said frame parallel to each other, or in any case arranged in such a way as to optimize the spaces available and reduce the overall dimensions of the machine.

### BRIEF DESCRIPTION OF THE DRAWING

The characteristics of the new filter press will be highlighted in greater detail in the following description, with reference to the enclosed drawing, attached as an example without limitation.

FIG. 1 shows a side view of a filter press according to the invention.

### DETAILED DESCRIPTION OF EMBODIMENTS OF THE INVENTION

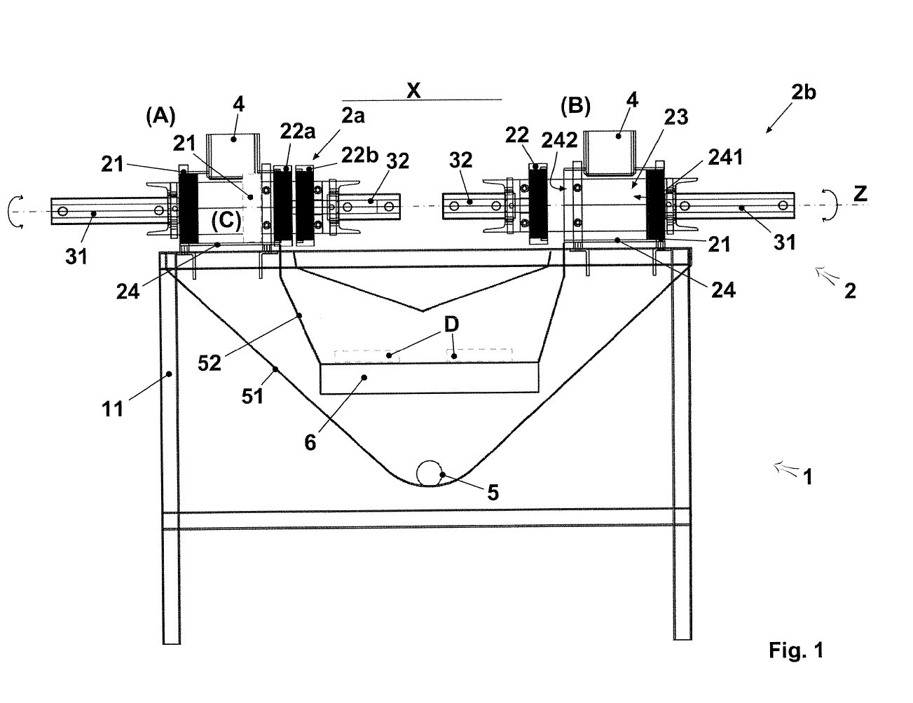

FIG. 1 shows a side view of the new filter press (1) according to the invention, comprising a frame (11) on which there are at least two pairs (2a, 2b) of facing porous plates (21, 22) defining between them a space (23) where a mass of mud to be dehydrated can be introduced and contained, wherein each plate (21, 22) comprises filtering or draining fabrics suited to drain the liquid fraction contained in the mass of mud. The left pair (2a) of plates (21, 22) is shown while in the loading position (A), meaning with said plates (21, 22) both arranged so as to close the two opposite ends (241, 242) of a tubular body (24), thus defining a closed space (23) in which the mud to be dehydrated can be introduced.

The right pair (2a) of plates (21, 22) is represented in the opening position (B) for the discharge of the wafer (D) of dehydrated mud through an open end (242) of said tubular body (24).

Said plates (21, 22) are suited to translate with respect to each other in a direction (X) in order to increase/decrease their mutual distance.

According to the invention, one or both of said plates (21, 22) is/are movable, that is, one or both of said plates (21, 22) can mutually translate in said direction (X). In detail, according to the invention one of said plates (22) of each pair (2a, 2b), called closing plate (22) here below, substantially translates between two positions (A, B), of which one is a loading position (A) and the other is an opening position (B).

In said loading position (A), visible in the right pair (2a) in FIG. 1, the closing plate (22a) is positioned to close one end (241) of said tubular body (24), while in said opening position (B) said closing plate (22b) moves back with respect to the tubular body (24), leaving said end (242) of the tubular body (24) open.

The second plate (21) of each pair (2a, 2b), called compression plate (21) here below, translates, instead, inside said tubular body (24) towards said closing plate (22) facing it, from said loading position (A), in which it is arranged so as to close the opposite end (242) of said tubular body (24), to a position of maximum compression (C), indicated by a dashed line in FIG. 1.

The new filter press also comprises mechanical members (3) suited to move one or both of said plates (21, 22) of each pair (2a, 2b), said mechanical members comprising for example fluid-operated cylinders (31, 32) acting directly or indirectly on one or both of said plates (21, 22) of each pair (2a, 2b).

Said plates (21, 22) of each pair (2a, 2b) in said closing position (A) thus define, together with said tubular body (24), a substantially closed space for the loading of the mud to be dehydrated.

For each pair (2a, 2b) of said facing plates (21, 22), the new filter press comprises at least one duct (4) suited to convey the mass of mud to be dehydrated into said space (23) included, between said plates (21, 22).

Once the mud to be dehydrated has been introduced in said closed space (23), said mechanical members (31) act on said compression plate (21) of each pair (2a, 2b), translating it towards said closing plate (22) in a position of compression (C) and thus exerting a compression force on the mass of mud.

Said compression force in said direction (X) is applied for a determined time interval, sufficient to cause the outflow of a liquid fraction contained in the mass of mud.

At the end of said time interval, maintaining in any case said compression force, that is, maintaining the mass of mud included between the plates (21, 22) under pressure, said mechanical members (31) act on one or both of said plates (21, 22), preferably on said compression plate (21), exerting also a twisting moment, by rotating said plate (21) on the plane where it lies around an axis (Z) that is substantially parallel to said direction (X) of application of the compression force. Said rotation of the compression plate (21) of each pair (2) causes the further outflow of a residual liquid fraction.

Said rotary motion is preferably alternated and associated with a vibratory motion, so as to maximize the quantity of liquid fraction removed from the mass of mud. The new filter press comprises also conveyors (51, 52) of the liquid fraction removed from the mass of mud through filtration per each one of said pairs (2a, 2b) of plates (21, 22) and at least one line or duct for the collection and outflow (5) of said liquid fraction.

The solid fraction that remains interposed between the plates (21, 22) of each pair (2a, 2b) forms a sort of panel or wafer (D) of dehydrated mud, having the dimensions of the space (23) between the plates (21, 22) in said position of maximum compression (C).

Once the dehydration process has been completed, the plates (21, 22) open, so that said dried mud panel thus obtained can be discharged.

In particular, said compression plate (21) moves back, returning to said loading position (A), while said closing plate (22) moves back to said discharge position (B), by substantially opening said end (242) of the tubular body (24) to discharge the wafer (D).

The wafer (D) is discharged by gravity or following a vibratory movement or another movement suited to cause the wafer (D) to fall on an underlying plane (6). Said plane (6) is for example a conveyor belt that carries the wafers (D) obtained towards a collection area.

In the preferred embodiment of the invention, two of said pairs (2a, 2b) of plates (21, 22) are aligned in series, that is, aligned along said direction (X) of application of the compression force, wherein said mechanical members (3) of each pair (2a, 2b) are mechanically connected to each other.

In particular, according to the invention the corresponding pneumatic cylinders (31, 32) of the two pairs (2a, 2b) are in fluid connection with each other through a single fluid circuit and operate in a reversed manner, that is, when the pneumatic cylinders (31, 32) of one pair (2a) are extended, that is, with the fluid under maximum pressure, the pneumatic cylinders (31, 32) of the other pair are withdrawn, that is, with the fluid under minimum pressure.

Said two pairs (2a, 2b) of plates (21, 22) constitute a modular unit (2) of the new filter press, wherein said modular units (2) can be arranged on said frame (11) parallel to each other, or in any case arranged so as to optimize the spaces, reducing the overall dimensions of the machine.

These are the schematic characteristics that are sufficient to carry out the invention for a person skilled in the art, consequently upon construction changes may be made that do not affect the substance of the innovative concept disclosed herein.

Therefore, with reference to the above description and the attached drawing, the following claims are expressed.

The invention claimed is:

1. A mechanical filtering process for dehydrating muds, comprising the steps of:
introducing a mass of mud to be dehydrated between porous plates for mechanical filtering; and
applying a compression force on the mass of mud by said porous plates to cause removal of a liquid fraction, which is filtered through the porous plates from the mass of mud, while a solid fraction remains between the porous plates,
wherein the step of applying said compression force comprises applying said compression force combined with at least one twisting moment on said mass of mud by said porous plates, thereby causing an additional removal of a residual liquid fraction from the mass of mud.

2. The process according to claim 1, wherein said twisting moment is applied alternately in the two directions, with or without a vibratory motion.

3. A filter press (1) for mechanical dehydration of muds, comprising:
a frame (11);
at least one pair (2a, 2b) of facing porous plates (21, 22) mounted on said frame (11) and defining, within at least one tubular body (24), a closed space (23) configured to receive and contain a mass of mud to be dehydrated, wherein each plate (21, 22) comprises filtering or draining fabrics configured to drain a liquid fraction contained in the mass of mud, said plates (21, 22) being arranged to translate in a direction (X) in relation to each other and to said tubular body (24) in order to increase/decrease their mutual distance;
at least one duct (4) configured to convey the mass of mud to be dehydrated into said closed space (23) between said plates (21, 22); and
mechanical members (3) suited to move one or both of said plates (21, 22), said mechanical members comprising fluid-operated cylinders (31, 32) acting directly or indirectly on one or both of said plates (21, 22) of each pair (2a, 2b) in order to move said plates (21, 22) near to or away from each other in said direction (X),
wherein said mechanical members (3) are configured to rotate at least one of said plates (21, 22) of said pair (2a, 2b) on a plane where the plates (21, 22) lie, around an axis (Z) that is substantially parallel to said direction (X) of the facing plates (21, 22).

4. The filter press (1) according to claim 3, wherein said fluid-operated cylinders (31, 32) are configured to act on said plates (21, 22) of said pair (2a, 2b) in order to exert a compression force in said direction (X) on the mass of mud introduced in the closed space (23) between the plates, thus removing the liquid fraction from the mass of mud, and
wherein, after a given time interval, maintaining maintaining the mass of mud included between the plates (21, 22) under pressure, said mechanical members (3, 31, 32) rotate at least one of said plates (21, 22) of said pair (2a, 2b) around said axis (Z), causing an additional outflow of a residual liquid fraction.

5. The filter press (1) according to claim 3, wherein said mechanical members (3, 31, 32) rotate at least one of said plates (21, 22) with a rotary motion alternated to or coupled to a vibratory motion.

6. The filter press (1) according to claim 3, further comprising conveyors (51, 52) of the liquid fraction removed from the mass of mud through filtration via said pair (2a, 2b) of plates (21, 22), and one line or duct for collection and outflow (5) of the liquid fraction removed from the mass of mud through the filtration.

7. The filter press (1) according to claim 3, wherein said plates (21, 22) are arranged to translate between the following positions:
a loading position (A), in which said plates (21, 22) are arranged to close both opposite ends (241, 242) of said tubular body (24);
a compression position (C), in which at least one of said plates (21) acting as a compression plate is translated towards the facing plate (22), acting as a closing plate, to obtain a mechanical compression necessary to dehydrate the mass of mud; and
an opening position (B), in which said compression plate (21) is moved backward to close a corresponding end (241) of said tubular body (24) while said closing plate (22) is moved backward with respect to said tubular body (24), opening a corresponding end (241) of said tubular body, thereby allowing a wafer (D) of dehydrated mud to be discharged.

8. The filter press (1) according to claim 3, wherein there is a plurality of pairs of plates, wherein two of said pairs (2a, 2b) of plates (21, 22) are arranged in series, making them aligned along said direction (X) of the compression force, wherein said mechanical members (3) of each pair (2a, 2b) are mechanically connected to each other, and wherein said two pairs (2a, 2b) of plates (21, 22) constitute a modular unit (2).

9. The filter press (1) according to claim 8, further comprising respective pneumatic cylinders (31, 32) of said two of said pairs (2a, 2b) fluid connection with each other through a single fluid circuit and operating in a reversed manner, thereby causing, when the pneumatic cylinders (31, 32) of one pair (2a) are extended, with the fluid under maximum pressure, the pneumatic cylinders (31, 32) of the other pair to be withdrawn, with the fluid under minimum pressure.

10. The filter press (1) according to claim 3, wherein there is a plurality of pairs of facing porous plates arranged on said frame (11), parallel to each other, such to optimize space and reduce overall dimensions.
